(19) United States
(12) Patent Application Publication
(10) Pub. No.: US 2025/0295265 A1
(43) Pub. Date: Sep. 25, 2025

(54) METHOD AND STEAM SEPARATOR FOR SEPARATING STEAM OUT OF A LIQUID-GAS MIXTURE, HOT WATER DISPENSER, METHOD FOR CLEANING A STEAM SEPARATOR, AND USE OF A STEAM SEPARATOR

(71) Applicant: JURA ELEKTROAPPARATE AG, Niederbuchsiten (CH)

(72) Inventors: Stephan Probst, Lohn-Ammannsegg (CH); Samuel Baltensperger, Ehrendingen (CH)

(73) Assignee: JURA ELEKTROAPPARATE AG, Niederbuchsiten (CH)

(21) Appl. No.: 18/861,305

(22) PCT Filed: May 11, 2023
(86) PCT No.: PCT/EP2023/062666

§ 371 Date: Oct. 29, 2024

(30) Foreign Application Priority Data
Jun. 3, 2022 (EP) 22177210.6

(51) Int. Cl. A47J 31/46; A47J 31/54; A47J 31/60

(52) U.S. Cl. CPC A47J 31/46; A47J 31/54; A47J 31/60

(57) ABSTRACT

The invention generally proposes a steam separator, a hot water dispenser and a method for separating steam from a liquid-gas mixture, wherein a liquid fraction of the liquid-gas mixture is collected and wherein a gas fraction is discharged above the collected liquid fraction, in particular wherein the gas fraction is a gas phase of the liquid fraction.

### CROSS-REFERENCE TO RELATED APPLICATIONS

This application is a national stage of International Application No. PCT/EP2023/062666 filed on May 11, 2023, which claims priority to European Patent Application No. 22177210.6 filed Jun. 3, 2022, both of which are hereby incorporated by reference in their entirety.

### FIELD OF THE INVENTION

The invention relates to a method for separating steam from a liquid-gas mixture.

### BACKGROUND OF THE INVENTION

The invention further relates to a steam separator having a fluid inlet and a fluid outlet and a chamber arranged between the fluid inlet and the fluid outlet, wherein at least one vent pipe terminates above a height of the chamber defined by the fluid inlet, wherein a partition wall is formed between the fluid inlet and the vent pipe, which preferably extends from above at least to below the height defined by the fluid inlet.

Liquid-gas mixtures can form in particular when a liquid is heated and/or when a liquid is transported in a heated state. For example, water can form steam at certain temperatures-a two-phase water-steam mixture can thus be created.

Water-steam mixtures can be problematic if water or a water-containing liquid is to escape from an opening, for example to be portioned. In fully automatic coffee machines, for example, it is disadvantageous if a coffee-steam mixture escapes from the machine, as splashes can occur due to the steam content. The higher the selected temperature level, for example a brewing level, the greater the proportion of steam and therefore the greater the risk of splashing. This means that many fully automatic coffee machines are limited in their maximum temperature level, which can reduce the quality of a coffee beverage.

The invention also relates to a hot water dispenser, in particular a fully automatic coffee machine.

The invention also relates to a method for cleaning a steam separator.

Finally, the invention relates to the use of a steam separator.

### SUMMARY OF THE INVENTION

The present invention is based on the object of improving the separation of steam from a liquid, in particular when working with hot water dispensers, preferably fully automatic coffee machines.

The features of claim 1 are provided according to the invention for solving the said objects. In particular, it is thus proposed according to the invention for solving the said object in a method of the type described at the beginning that a liquid fraction of the liquid-gas mixture is collected and wherein a gas fraction is discharged above the collected liquid fraction, in particular wherein the gas fraction is a gas phase of the liquid fraction. By collecting the liquid-gas mixture, preferably in a chamber as described or claimed below, a certain volume of a liquid fraction can be separated from a gas fraction. Collecting the liquid-gas mixture can be particularly advantageous if a liquid fraction is to be portioned. Another advantage of the method according to the invention is that the separation of the gas fraction from the liquid fraction is particularly efficient due to the collection of the liquid-gas mixture. This can improve the operation of hot water dispensers, for example.

In the method according to the invention, the gas fraction above the collected liquid fraction is advantageously removed. Thus, in particular a gas fraction, for example water steam, can be discharged easily and preferably without further method steps or discharge devices. This is particularly useful for hot water dispensers, especially fully automatic coffee machines, in which water is heated and water steam is produced, i.e. in particular where the gas fraction is a gas phase of the liquid fraction. It is particularly advantageous that the gas fraction discharged above the collected liquid fraction does not interfere with the flow, in particular the discharge, of the liquid fraction.

The method according to the invention is preferably carried out with a steam separator. Particularly preferably, a steam separator as claimed herein and described below can be used.

In an advantageous design, it may be provided that an inflow of liquid-gas mixture and an outflow of the collected liquid fraction are dimensioned in such a way that a level of the liquid fraction is formed. The advantage of a level can be that a surface of the liquid fraction is created which can be kept at a certain height. As a result, the efficiency of the separation of the gas fraction from the liquid fraction can be particularly high.

In an advantageous design, it may be provided that inflowing liquid-gas mixture is supplied to the collected liquid fraction, in particular—at least for a gas fraction below a threshold value—is introduced below the level. In this way, a liquid-gas mixture can be continuously fed to the liquid fraction, whereby a level can at least be maintained or even formed or increased. In this way, the efficiency of the separation of the gas fraction from the liquid fraction can be stabilized and/or regulated. A further advantage may be that bubbles and turbulence in the liquid fraction can be avoided by supplying below the level. This means that a method can be adapted to different temperature levels. If the gas fraction increases, the level will often decrease. This means that if there is a high gas fraction, the discharge can take place above the level. In cleaning mode with a very low gas fraction or no gas fraction, on the other hand, the discharge will take place below the water level.

In an advantageous design, it may be provided that, in a purification step, an inflow of liquid-gas mixture is increased and/or an outflow of the collected liquid fraction is reduced in such a way that a discharge for the gas fraction is flooded. Thus, during a cleaning step, a liquid can be directed via the discharge, for example the vent pipe described and/or claimed below, for the gas fraction, so that the discharge can also be cleaned. In this way, for example, limescale deposits can be removed, which can reduce or prevent clogging of the discharge in particular. Overall, a steam separator described or used as described below can therefore preferably be cleaned, which means that the steam separator can have a particularly long service life.

In particular, the temperature of the liquid-gas mixture can be reduced in such a way that the gas fraction is reduced or approaches zero. This means that a cleaning step can be carried out without the formation of gas bubbles in the liquid fraction, which means that cleaning can be carried out in a particularly uniform manner.

In an advantageous design, it may be provided that an inflow of liquid-gas mixture is controlled by a phase control on a pump. For example, it may be provided that the pump can be used to regulate the volume flow of the inflow. It may be provided that a device in which a method for separating steam from a liquid-gas mixture is carried out, in particular a steam separator as described or claimed below, fills up at maximum inflow. This can be provided for cleaning the device. The shorter the working pause of the pump, the greater the inflow can be over the entire time of a cleaning process. In this way, the pump can be used to increase the inflow of liquid-gas mixture, for example by cycling the pump, in such a way that the discharge for the gas fraction is flooded, as described above. The pump can therefore be used to switch advantageously between different operating modes.

Alternatively or additionally, the features of the alternative independent claim directed to a steam separator are provided according to the invention for solving the said object. In particular, it is thus proposed according to the invention for solving the said object in a steam separator of the type described at the beginning that the partition wall leaves a relief opening in one or more regions which is arranged higher than the vent pipe. The relief opening prevents the chamber from being divided into two separate areas. This prevents overpressure in the steam separator. This can calm the flow of liquid or reduce bubbling of the liquid. Furthermore, the relief opening allows the gas fraction separated from the liquid at the partition wall to be directed to the vent pipe. This can improve the separation of a gas fraction from a liquid.

Furthermore, a liquid can be heated to a particularly high temperature in a steam separator according to the invention. Thus, the invention has recognized that by using the steam separator, a liquid, for example water, can be heated up to 100° C., preferably 97° C., without a gas or steam separation affecting the liquid outlet from the steam separator. As a result, an operating temperature of a hot water dispenser as described and/or claimed herein can advantageously be high.

The steam separator according to the invention is further suitable to be used in a method described and/or claimed herein. Thus, steam separation can be performed particularly efficiently, especially when the steam separator is located in a hot water dispenser as described and/or claimed hereinbelow.

Since the vent pipe of the steam separator according to the invention ends above a height of the chamber defined by the fluid inlet, a particularly large volume of liquid-gas mixture can enter the chamber through the fluid inlet or form a level. This means that a large proportion of gas can be separated from a liquid relatively quickly.

Separation takes place at the partition wall, which preferably acts as a rebound surface against which the incoming liquid-gas mixture bounces off. Bouncing off the partition wall is particularly effective, as the partition wall extends from above at least to below the height defined by the fluid inlet. This is because a particularly large rebound surface can be formed by the partition wall. After rebounding, the separated gas fraction can be collected in the chamber so that the gas fraction does not interfere with the flow of the liquid fraction out of the fluid outlet. In this way, an escaping liquid can be particularly free of gases, for example gas bubbles. This is particularly advantageous if the steam separator is installed in a hot water dispenser, especially in a fully automatic coffee machine.

In an advantageous design, it may be provided that the fluid inlet is directed preferably transversely towards the partition wall. This allows the incoming liquid-gas mixture to impact advantageously on the partition wall, whereby separation of the gas fraction and the liquid fraction can be carried out particularly effectively.

In an advantageous design, it may be provided that the partition wall does not adjoin a chamber wall of the chamber in the horizontal direction. Thus, a connection opening, in particular the one described herein, can be formed so that a liquid fraction can advantageously flow through the chamber. In particular, the liquid fraction can flow through a large and a small part of the chamber. Thus, a flow of the liquid fraction through the steam separator can be advantageously realized.

In an advantageous design, it may be provided that the fluid outlet has a larger opening cross-section than the fluid inlet. This can ensure that a liquid is discharged faster than it can enter, which is particularly advantageous if the gas fraction is separated from the liquid fraction when the liquid-gas mixture impacts the partition wall. The rapid discharge of the liquid fraction can prevent the separated gas fraction from mixing with the liquid fraction again.

In an advantageous design, it may be provided that the partition wall is preferably integrally connected to a chamber lid. The chamber lid can be designed as the wall of the chamber so that the chamber can be advantageously closed by the chamber lid. Due to the integral connection of the chamber lid and partition wall, additional components, such as connecting elements, are not required for the construction of the chamber. It can also be advantageous that the partition wall is positioned correctly in the chamber by attaching the chamber lid to the chamber.

In an advantageous design, it may be provided that the partition wall is supported on the vent pipe. This allows the partition wall to be advantageously stabilized on the vent pipe. The partition wall can also be guided through the vent pipe when it is inserted into the chamber, especially if, as mentioned herein, the partition wall is integrally connected to a chamber lid. This can simplify the overall assembly of a steam separator.

In an advantageous design, it may be provided that the fluid outlet opens into the chamber at a lower height than the fluid inlet. Thus, the liquid fraction, which is located in the chamber and is preferably separated from the or a gas fraction, can advantageously flow out of the chamber, preferably by gravity. This means that the liquid separated from the gas fraction can flow out without any further devices.

In an advantageous design, it may be provided that the partition wall has at least one connection opening at a height below the fluid inlet. The connection opening can therefore be formed at least partially through the partition wall. The liquid can flow through the chamber through this connection opening so that the liquid fraction, which is preferably separated from the gas fraction, can be guided to the fluid outlet, for example.

The connection opening can extend over a longitudinal dimension, for example over a diameter, of a base area of the chamber. This allows a particularly large volume of liquid to flow through the chamber. Alternatively, at least two connection openings can preferably be formed over the longitudinal extension.

In an advantageous design, it may be provided that an opening cross-section of the connection opening is larger than an opening cross-section of the fluid outlet, for example the aforementioned opening cross-section. This means that more liquid fraction can be guided towards the fluid outlet than can escape as liquid fraction through the fluid outlet. Thus, in particular, a level can be formed or maintained which is the chamber area in which the fluid inlet does not open. Thus, a total level can be formed which occupies a particularly large area, whereby a particularly large gas fraction can be advantageously separated per time.

In an advantageous design, it may be provided that an opening cross-section of the connection opening, for example the one already mentioned, is larger than an opening cross-section of the fluid inlet, for example the one already mentioned. This allows the level to be formed in the chamber area in which the fluid inlet opens. As a result, a total level can be formed which occupies a particularly large area, whereby a particularly large gas fraction can be separated per time.

A level can be formed particularly advantageously and thus the separation of a gas fraction can be achieved efficiently if an opening cross-section of the connection opening, for example the one already mentioned, is larger than an opening cross-section of the fluid inlet, for example the one already mentioned, and larger than an opening cross-section of the fluid outlet, for example the one already mentioned.

In an advantageous design, it may be provided that the fluid inlet opens into an upper half of the chamber. This allows the chamber to be filled with a particularly large volume of liquid, preferably at least half of the chamber volume. In this way, a particularly large volume of liquid can be separated from a gas fraction and then portioned. Furthermore, the fluid inlet positioned in the upper half of the chamber enables an opening cross-section of a connection opening, in particular that described herein, to be particularly large. This can further improve the separation of the gas fraction from the liquid.

In an advantageous design, it may be provided that the partition wall extends from the top into a lower half of the chamber. Thus, in particular, the connection opening described herein can be located near the bottom of the chamber and/or positioned close to the fluid outlet. This allows a flow of the liquid fraction from one part of the chamber to another part of the chamber away from the relief opening described herein. Thus, flooding of the vent pipe can be avoided.

In an advantageous design, it may be provided that the partition wall extends from above to a height that is below the fluid inlet by at least one clear internal dimension of the fluid inlet. This can ensure that the entire volume of the liquid-gas mixture entering through the fluid inlet bounces off the partition wall. As a result, the entire liquid fraction can be separated from the gas fraction.

Alternatively and/or additionally, it may be provided that the partition wall extends from above to a height that is at least a distance between the fluid inlet and the partition wall below the fluid inlet. This can advantageously prevent the liquid-gas mixture from bouncing off the partition wall and back into the fluid inlet and/or prevent a liquid fraction and/or a gas fraction from passing through the fluid inlet.

In an advantageous design, it may be provided that a clear height of the chamber is greater than a clear lateral dimension. This means that a chamber can be advantageously narrow, for example in the form of a cylinder. A narrow design of the chamber or steam separator can be particularly advantageous if the steam separator is to be of narrow design, for example in order to take up little space in a hot water dispenser, especially in a fully automatic coffee machine.

In an advantageous design, it may be provided that the partition wall divides the chamber into a larger part and a smaller part. Dividing the chamber into a large and a small part can optimize the level formation of the liquid. Furthermore, gas separation can be particularly effective, especially if the smaller part of the chamber is located between the fluid inlet and the partition wall. Thus, the path of the liquid-gas mixture from the fluid inlet to the partition wall can be short, so that the liquid-gas mixture bounces off the partition wall at a high pressure, which can promote separation.

In an advantageous design, it may be provided that the relief opening extends from below the chamber lid to a height that is at least one clear internal dimension of the fluid inlet above the fluid inlet. This allows sufficient area to be formed between the point of impact of the liquid-gas mixture on the partition wall and the relief opening so that little or no liquid passes through the relief opening after the liquid-gas mixture has impacted. This can prevent liquid from entering the vent pipe.

In an advantageous design, it may be provided that at least a large part of a clear internal dimension of at least one relief opening does not extend over a preferably vertical axis of symmetry of the partition wall. In such a design, the at least one relief opening can be arranged at the side of the partition wall so that the liquid can be prevented from passing through the relief opening after the liquid-gas mixture has impacted.

It may be provided that at least two relief openings are arranged next to each other on the partition wall, in particular that the clear internal dimensions of the relief openings do not extend over the vertical axis of symmetry of the partition wall. This also prevents the liquid from entering the vent pipe.

Alternatively or additionally, the features of the alternative independent claim directed to a hot water dispenser are provided according to the invention for solving the said object. In particular, it is thus proposed according to the invention for solving the said object in a hot water dispenser of the type described at the beginning that the hot water dispenser is provided with a heating unit for providing hot water and a steam separator fluidically connected to the heating unit and as described and/or claimed herein. Thus, a hot water dispenser can dispense hot water without splashing. By using a steam separator described and/or claimed herein, the heating unit can direct hot water and/or hot water beverage (for example a coffee preparation) up to 100° C., preferably 97° C., to the steam separator so that the hot water dispenser can dispense particularly hot water and/or hot water beverage without splashing.

In particular, it may be provided that the hot water dispenser can be designed as a fully automatic coffee machine. Due to the high operating temperatures, a particularly aromatic and delicious coffee preparation can be dispensed.

Alternatively or additionally, the features of the alternative independent claim directed to a method for cleaning a steam separator are provided according to the invention for solving the said object. Thus, in particular, in order to solve the said object in a method for cleaning a steam separator of the type described at the beginning, it is proposed according to the invention that, in a steam separator as described and/or claimed herein, the chamber is flooded until water emerges from the vent pipe. Thus, the entire steam separator can be cleaned in one cleaning process. As a result of the regular steam separation process, for example by a method of steam separation described and/or claimed herein, the vent pipe of the steam separator may become fouled with deposits. These deposits can impair the venting function of the vent pipe and thus the performance of the steam separator. It is therefore particularly advantageous that the cleaning process according to the invention can also be used to clean the vent pipe and remove deposits, for example limescale deposits.

Alternatively or additionally, the features of the alternative independent claim directed to the use of a steam separator are provided according to the invention for solving the said object. In particular, it is thus proposed in accordance with the invention, in order to solve the said object when using the type described at the beginning, that the fluid inlet forms the inflow for the liquid-gas mixture and/or the liquid fraction collects in the chamber and/or the gas fraction is discharged via the vent pipe and/or the fluid outlet forms the outflow of the collected liquid fraction. In this way, the separation of steam from a liquid can be particularly improved. This is particularly advantageous if the steam separator is used in the aforementioned fully automatic coffee machine. In this way, a particularly tasty coffee preparation can be dispensed without splashing.

The invention will now be described in more detail with reference to exemplary embodiments, but is not limited to these exemplary embodiments. Further exemplary embodiments are obtained by combining the features of individual or several claims with one another and/or with individual or several features of the exemplary embodiments, wherein:

### BRIEF DESCRIPTION OF THE DRAWINGS

FIG. 1 shows a steam separator according to the invention during a steam separation process,

FIG. 2 shows a hot water dispenser according to the invention and designed as a fully automatic coffee machine with the steam separator from FIG. 1,

FIG. 3 shows a hot water pipe of the steam separator according to the invention shown in FIG. 1,

FIG. 4 shows a chamber lid of the steam separator according to the invention shown in FIG. 1.

### DETAILED DESCRIPTION

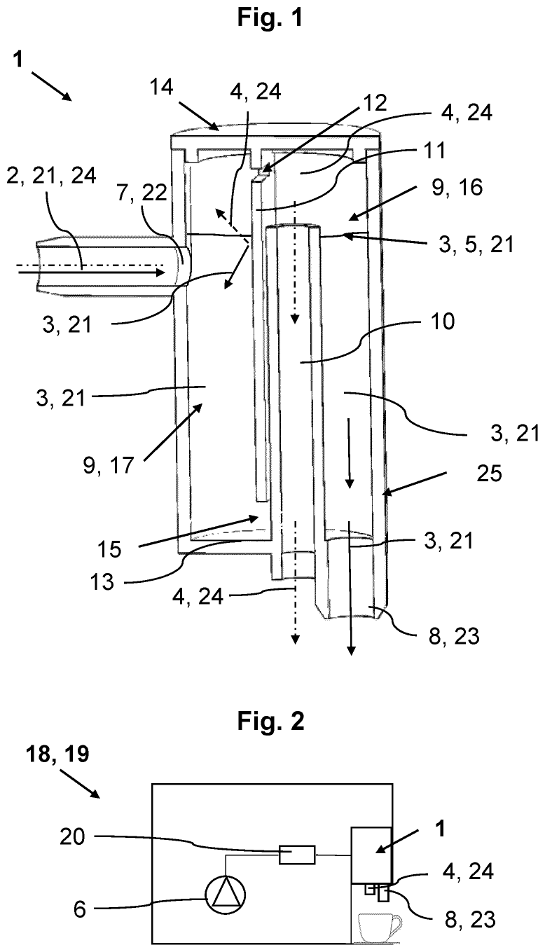

FIG. 1 shows a steam separator 1 according to the invention during a steam separation process. The steam separator 1 is installed in a hot water dispenser 18 according to the invention and designed as a fully automatic coffee machine 19, as shown in FIG. 2.

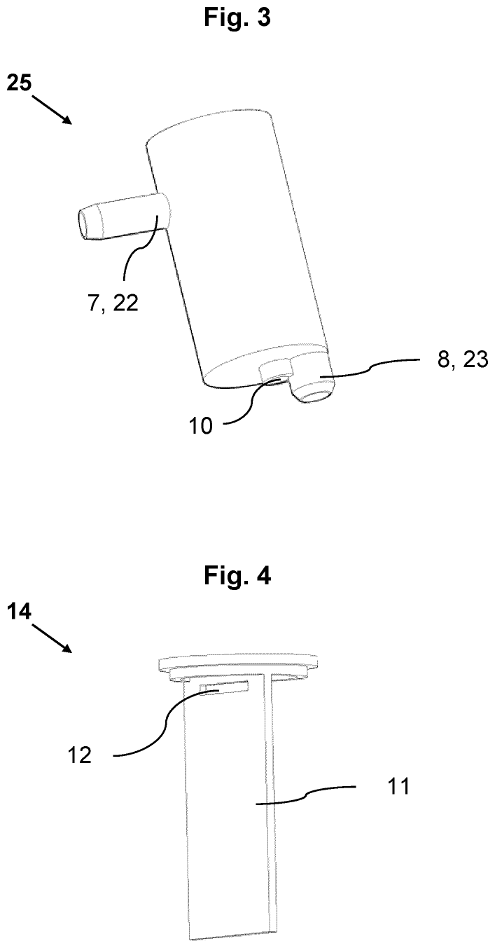

The steam separator 1 is composed of a chamber lid 14 (FIG. 4) and a hot water pipe 25 (FIG. 3). In the assembled state, the chamber lid 14 and the hot water pipe 25 are non-detachably assembled, so that the steam separator 1 is particularly robust and watertight, which can advantageously prevent preferably water 21 and/or cleaning fluid from escaping from the steam separator 1.

The steam separator 1 in FIG. 1 has a fluid inlet 7 and a fluid outlet 8 and a chamber 9 arranged between the fluid inlet 7 and the fluid outlet 8, wherein a vent pipe 10 ends above a height of the chamber 9 defined by the fluid inlet 7. FIG. 1 thus clearly shows that the level 5 of the liquid fraction 3, 23 is formed above the opening of the fluid inlet 7 and below the opening of the vent pipe 10. For an advantageous outflow of the liquid fraction 3, 21, the fluid outlet 8 is arranged so that it opens into the chamber 9 below the opening of the fluid inlet 7.

The chamber 9 of the steam separator 1 is designed in such a way that its clear height is greater than a clear lateral dimension. Thus, the chamber 9 of the embodiment shown in FIG. 1 is cylindrical in shape. Thus, the steam separator 1 can be compact, preferably elongated, in particular in the form of an elongated pipe, in order to be installed in a hot water dispenser 18, in particular the fully automatic coffee machine 18, 19 shown in FIG. 2, in a space-saving manner.

The liquid (solid arrow) and gas (dashed arrow) mixture 2, represented by a solid/dashed double arrow, enters the chamber 9 via the fluid inlet 7. The liquid-gas mixture 2 shown in FIG. 1 has water 21 or an aqueous solution (e.g. coffee) as the liquid fraction 3 and water steam 24 as the gas fraction 4, i.e. a gas phase of the heated water 21. The liquid-gas mixture 2 shown in FIG. 1 has water 21 or an aqueous solution (e.g. coffee) as the liquid fraction 3 and water steam 24, i.e. a gas phase of the heated water 21, as the gas fraction 4. An inflow 22 of the liquid-gas mixture 2, 21, 24 can be controlled or timed by a phase gate on a pump 6 of the hot water dispenser 18, 19 upstream of a heating unit 20. (see FIG. 2).

The incoming liquid-gas mixture 2, 21, 24 bounces off a partition wall 11 in the chamber 9, which is integrally connected to the chamber lid 14 and extends from above to below the height defined by the fluid inlet 7. This ensures that the entire incoming volume of the liquid-gas mixture 2, 21, 24 is separated into a gas fraction 4, 24 and a liquid fraction 3, 21.

The fluid inlet 7 is directed transversely towards the partition wall 11, so that the liquid-gas mixture 2, 21, 24 impinges on the partition wall, whereby the separation of the gas fraction 4, 24 from the liquid fraction 3, 21 is carried out particularly effectively, as shown schematically in FIG. 1 by means of the dashed arrow (4, 24) extending from the partition wall 11 and the continuous arrow (3, 21) extending from the partition wall 11.

The partition wall 11 is supported on the vent pipe 10, thus preferably forming a contacting area with the vent pipe 10, and is thus optimally positioned in the chamber 9, so that the chamber 9 is divided into a larger part 16 and a smaller part 17, wherein the larger part 16 is connected to the fluid outlet 8 and the smaller part 17 is connected to the fluid inlet 7. As a result, separation of the gas fraction 4, 24 from the liquid fraction 3, 21 can be particularly effective, since the path of the liquid-gas mixture 2, 21, 24 from the fluid inlet 7, 22 to the partition wall 11 is relatively short.

The separated gas fraction 4, 24 can escape via the relief opening 12 in the direction of the vent pipe 10. The relief opening 12 is arranged higher than the vent pipe 10 in one or more areas. The relief opening 12 also prevents excess pressure from building up in the chamber 9. If there were no relief opening 12 in the partition wall 11, as shown in FIG. 1 for example, this could lead to excess pressure in the chamber 9, which could at least damage the steam separator 1.

The relief opening 12 extends from below the chamber lid 14 to a height which is above the fluid inlet 7 by a clear internal dimension of the fluid inlet 7. This prevents a liquid fraction 3, 21 from entering the vent pipe 10 through the relief opening 12, in particular during the separation of the gas fraction 4, 24 from the liquid fraction 3, 21.

Alternatively or additionally, spillage of a liquid fraction 3, 21 into the vent pipe 10 could be prevented by ensuring that at least a large part of a clear internal dimension of at least one relief opening 12 does not extend over a preferably vertical axis of symmetry of the partition wall 11. For example, two relief openings 12 may not be positioned centrally, but rather at the edge of, for example, the aforementioned partition wall 11 (not shown).

For the flow of the liquid fraction 3, 21 from the smaller part 17 into the larger part 16 of the chamber 9, the partition wall 11 has a connection opening 15 at a height below the fluid inlet 7, which has an opening cross-section that is larger than the opening cross-sections of the fluid inlet 7 and the fluid outlet 8. The connection opening 15 is also partially formed by a preferably horizontally aligned chamber wall 13, to which the partition wall 11 is tightly connected in the horizontal direction.

FIG. 1 also shows that the fluid outlet 8 has a larger opening cross-section than the fluid inlet 7. This prevents the level 3, 5, 21 from rising above an opening of the vent pipe 10 and flooding it, as more fluid 3, 21 can flow out via the fluid outlet 8 than enters the chamber 9 via the fluid inlet 7.

In the following, a possible method for steam separation is described, wherein a steam separator 1 described herein, in particular that disclosed in FIG. 1, is used in a fully automatic coffee machine 18, 19 as shown in FIG. 2.

In the method for steam separation, the liquid fraction 3, 21 of the liquid-gas mixture 2, 21, 24 (preferably water in this case) at temperatures of up to 100° C. collects in the chamber 9 and the gas fraction 4, 24 is discharged above the collected liquid fraction 3, 21 and further discharged from the steam separator 1 through the vent pipe 10 (FIG. 1).

The inflow 22 of the liquid/gas mixture 2, 21, 24 and an outflow 23 of the collected liquid fraction 3, 21 are dimensioned so that a level 5 of the liquid fraction 3, 21 forms in the chamber 9 (FIG. 1). In this way, separation of the gas fraction 4, 24 can be carried out optimally.

In the method, the liquid-gas mixture 2, 21, 24 is fed to the collected liquid fraction 3, 21 below its level 5. This prevents the liquid-gas mixture 2, 21, 24 flowing downstream from bouncing off the surface of the level 5 of the collected liquid fraction 3, 21 and causing splashes which, for example, enter the vent pipe 10 via the relief opening 12.

Overall, the method leads to improved steam separation. Thus, it can be advantageously prevented that the liquid 3, 21 to be dispensed, for example water, leaves the fully automatic coffee machine irregularly and/or with splashes. By using the steam separator 1 or by carrying out the method described, an operating temperature of up to 100° C. can be used, as the gas fraction 4, 24 is separated from the liquid fraction 3, 21. Thus, the quality of a coffee-water product, e.g. Caffè Americano, or another hot water beverage, e.g. tea, can be improved in particular, as a higher operating temperature can lead to a better enjoyment experience, as is the case in the embodiments described here.

The control of the inflow 22 of the liquid-gas mixture 2, 21, 24 is controlled by a phase control on a pump 6. Thus, for example, the volume flow per time can be controlled via the fluid inlet 7. In the method for cleaning a steam separator 1, it may be provided that the inflow 22 of water 21 is preferably controlled by a phase control of the pump 6, so that the chamber 9 is flooded until water 21 emerges from the vent pipe 10. In this way, the vent pipe 10 can also be cleaned and freed from limescale deposits. As a result, the fully automatic coffee machine 18, 19 can be particularly durable, which is especially customer-friendly.

The invention generally proposes a steam separator 1, a hot water dispenser 18, 19 and a method for separating steam from a liquid-gas mixture 2, wherein a liquid fraction 3 of the liquid-gas mixture 2 is collected and wherein a gas fraction 4 is discharged above the collected liquid fraction 3, in particular wherein the gas fraction 4 is a gas phase of the liquid fraction 3. The invention is of particular interest in the luxury food industry, but is not limited to this field.

1-25. (canceled)

26. A steam separator, having a fluid inlet and a fluid outlet and a chamber arranged between the fluid inlet and the fluid outlet, wherein at least one vent pipe is present which ends above a height of the chamber defined by the fluid inlet, wherein a partition wall is formed between the fluid inlet and the vent pipe, which preferably extends from above at least to below the height defined by the fluid inlet, wherein the partition wall leaves a relief opening in at least one region which is arranged higher than the vent pipe.

27. A steam separator according to claim 26, wherein the fluid inlet is directed preferably transversely towards the partition wall.

28. A steam separator according to claim 26, wherein the partition wall adjoins a chamber wall of the chamber closely in the horizontal direction.

29. A steam separator according to claim 26, wherein the fluid outlet has a larger opening cross-section than the fluid inlet.

30. A steam separator according to claim 26, wherein the partition wall is preferably integrally connected to a chamber lid.

31. A steam separator according to claim 26, wherein the partition wall is supported on the vent pipe.

32. A steam separator according to claim 26, wherein the fluid outlet opens into the chamber at a lower height than the fluid inlet.

33. A steam separator according to claim 26, wherein the partition wall has at least one connection opening at a height below the fluid inlet.

34. A steam separator according to a claim 33, wherein the at least one connection opening is larger than the or an opening cross-section of the fluid outlet.

35. A steam separator according to claim 34, wherein an opening cross-section of the connection opening is larger than the or an opening cross-section of the fluid inlet.

36. A steam separator according to claim 26, wherein the fluid inlet opens into an upper half of the chamber.

37. A steam separator according to claim 26, wherein the partition wall extends from the top into a lower half of the chamber.

38. A steam separator according to claim 26, wherein the partition wall extends from above to a height which is below the fluid inlet by at least one clear internal dimension of the fluid inlet and/or by at least one distance between the fluid inlet and the partition wall.

39. A steam separator according to claim 26, wherein a clear height of the chamber is greater than a clear lateral dimension.

40. A steam separator according to a claim 26, wherein the partition wall divides the chamber into a larger part and a smaller part, in particular wherein the larger part is connected to the fluid outlet and/or the smaller part is connected to the fluid inlet.

41. A steam separator according to claim 30, the relief opening extends from below the chamber lid to a height which is above the fluid inlet by at least one clear internal dimension of the fluid inlet.

42. A steam separator according to claim 26, wherein at least a large part of a clear internal dimension of at least one relief opening does not extend over a preferably vertical axis of symmetry of the partition wall.

43. A method for separating steam from a liquid-gas mixture, having a steam separator according to claim 26, wherein a liquid fraction of the liquid-gas mixture is collected and wherein a gas fraction is discharged above the collected liquid fraction, in particular wherein the gas fraction is a gas phase of the liquid fraction.

44. A method according to claim 43, wherein an inflow of liquid-gas mixture and an outflow of the collected liquid fraction are dimensioned such that a level of the liquid fraction is formed.

45. A method according to claim 43, wherein inflowing liquid-gas mixture is fed to the collected liquid fraction.

46. A method according to claim 43 wherein in a purification step, an inflow of liquid/gas mixture is increased and/or an outflow of the collected liquid fraction is reduced in such a way that a discharge for the gas fraction is flooded, in particular wherein a temperature of the liquid/gas mixture is reduced in such a way that the gas fraction is reduced or approaches zero.

47. A method according to claim 43, wherein an inflow of liquid-gas mixture is controlled by a phase control on a pump.

48. A hot water dispenser, in particular, a fully automatic coffee machine, having a heating unit for providing hot water, the heating unit fluidically connected to the steam separator of claim 26.

49. A method for cleaning a steam separator according to claim 26, wherein the chamber is flooded until water emerges from the vent pipe.

50. The use of a steam separator according to claim 26, in particular wherein the fluid inlet forms the inflow for the liquid-gas mixture and/or the liquid fraction collects in the chamber and/or the gas fraction is discharged via the vent pipe and/or the fluid outlet forms the outflow of the collected liquid fraction.
